(19) United States
(12) Patent Application Publication
(10) Pub. No.: US 2009/0290258 A1
(43) Pub. Date: Nov. 26, 2009

(54) STORAGE DEVICE EQUIPPED WITH RAMP MECHANISM

(75) Inventors: Yoshiharu Matsuda, Kawasaki (JP); Masaya Suwa, Toshima (JP); Ritsuko Minamisawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/511,869

(22) Filed: Jul. 29, 2009

Related U.S. Application Data
(63) Continuation of application No. PCT/JP2007/056473, filed on Mar. 27, 2007.

(51) Int. Cl. G11B 15/60

(52) U.S. Cl. 360/130.2; G9B/15.076

(57) ABSTRACT

In a load/unload type disk drive, when a head for reading/writing information on a disk is retracted outside the disk by a swing arm at the time of stopping the operation of the disk drive, a ramp mechanism holds a lift tab provided at the tip of the swing arm, wherein the ramp mechanism comprises a holding member for holding the lift tab and a mounting member for mounting the holding member thereon, the mounting member having a guide capable of adjusting the mounting position. The holding member mounted on the mounting member is tentatively fastened thereto, with provisions made to be able to adjust the position of the thus mounted holding member by moving it along the guide in a direction conforming to the rotational path of the holding member.

### CROSS-REFERENCE TO RELATED APPLICATION

This application is a continuation application based upon and claims priority of International application No. PCT/JP2007/056473, filed on Mar. 27, 2007, the contents being incorporated herein by reference.

### FIELD

The present invention relates to a storage device equipped with a ramp mechanism, and more particularly to a storage device, such as a load/unload type magnetic disk drive, that is equipped with a ramp mechanism for holding a slider-mounted magnetic head at a position near the outer diameter of a magnetic disk when the magnetic head is unloaded.

### BACKGROUND

Usually, in a computer, data is stored on an external storage device that can hold stored data even when power to the device is removed. Examples of such external storage devices include semiconductor memories, optical disks, and magnetic disk drives, among which magnetic disk drives are in widespread use because of their large storage capacity. Hard disk drives comprising data storage platters coated with a magnetic material and magnetic heads for reading and writing data on the platters are the predominant type of magnetic disk drive in use today. The platters employed with the hard disk drives are composed of a stack of aluminum or glass disks each coated with a magnetic material, and the magnetic heads are used to read and write data on the disks that are being rotated at high speed by a motor.

There are two types of hard disk drives, the contact start/stop (CSS) type and the load/unload type. In the CSS type, when the magnetic disk is stationary, the magnetic head is in contact with the magnetic disk, but when the magnetic disk starts rotating, the magnetic head moves up and floats above the magnetic disk, and when the magnetic disk stops rotating, the magnetic head again contacts the magnetic disk. In the CSS type, the magnetic head lands on an inner diameter area (CSS zone) other than the data storage area of the magnetic disk. The head slider containing the magnetic head is provided with legs to prevent the entire structure of the slider from contacting the disk and sticking to it when the magnetic head lands on the magnetic disk.

On the other hand, in the load/unload type, when the magnetic disk is stationary, the magnetic head attached at the tip of a swing arm, i.e., a magnetic head actuator, is unloaded from the magnetic disk surface, and when the magnetic disk starts rotating, the magnetic head is loaded onto the magnetic disk surface. In the load/unload type hard disk drive, a lift tab which is used to lift the magnetic head off the disk surface for unloading is provided in protruding fashion at the tip of the swing arm. A ramp mechanism for guiding and holding the lift tab thereon is provided within the housing of the hard disk drive at a position near the outer diameter of the magnetic disk.

When the swing arm is turned toward the outer diameter of the magnetic disk to unload the magnetic head from the magnetic disk surface, the lift tab is guided by the ramp mechanism and held thereon thus keeping the magnetic head from contacting the magnetic disk. Such load/unload type hard disk drives are disclosed, for example, in U.S. Pat. No. 5,237,472 and U.S. Pat. No. 5,574,604. Generally, the load/unload type is widely used for magnetic disk drives of which impact resistance is demanded.

In U.S. Pat. No. 5,237,472, the ramp mechanism is provided outside the outer diameter of the magnetic disk, while in U.S. Pat. No. 5,574,604, the ramp mechanism is located at the inner diameter of the magnetic disk. In U.S. Pat. No. 5,237,472, the ramp mechanism is fixed in a manner that permits it to be finely adjusted using a bolt inserted in a cross-shaped slot, while on the other hand, the ramp mechanism disclosed in U.S. Pat. No. 5,574,604 is rigidly fixed at two points.

When the ramp mechanism is provided outside the outer diameter of the magnetic disk, as in the case of the ramp mechanism disclosed in U.S. Pat. No. 5,237,472, the ramp mechanism is constructed separately from the base, and the ramp mechanism is fixed by positioning it using two wall faces provided on the base of the housing of the hard disk drive.

### SUMMARY

However, with the fine adjustment structure for the ramp mechanism disclosed in patent document 1, the fine adjustment is achievable only in straight line directions, and the direction of the fine adjustment does not match the direction of movement of the magnetic head; on the other hand, when the ramp mechanism is fixed via the two wall faces to the base of the housing, there arises a problem that the mounting position of the ramp mechanism cannot be finely adjusted, resulting in an inability to properly retract the gimbal spring when unloading the head. If the mounting position of the ramp mechanism to the base cannot be optimally adjusted, the position where the lift tab contacts the ramp mechanism in sliding fashion may be displaced from the proper position depending on the accuracy with which the load beam is mounted to the head actuator, and the head slider may strike the magnetic disk surface. To change the ramp mechanism positioning, equipment for assembling the ramp mechanism, etc., has to be changed accordingly, which would involve a great deal of time and cost.

It is also known that the sliding motion of the lift tab with respect to the ramp mechanism results in the generation of friction particles. In recent magnetic disk drives, since the flying height of the head is extremely small (for example, on the order of 10 nm), any friction particle falling on the magnetic disk could cause a head crash. Therefore, accurately positioning the ramp so as to permit the lift tab to slide along the ramp mechanism under favorable conditions is critical to prevent the generation of friction particles.

To prevent the generation of friction particles, the area of contact between the ramp mechanism and the lift tab must be made relatively small. This makes it difficult to accurately position the ramp mechanism, and if the lift tab fails to correctly contact the ramp mechanism, excessive force may be applied to the lift tab and the contact point on the ramp mechanism when holding the head in position, and this can result in an inability to suppress the generation of friction particles. In addition to that, if an external impact is applied, the lift tab may, in a worst case, fall off the ramp mechanism. It is therefore important to correctly position the ramp mechanism within the housing so that the ramp can hold the head under favorable conditions.

In view of the above, it is an object of the present invention to provide a storage device equipped with a ramp mechanism that permits the position of the ramp mechanism relative to the lift tab to be properly adjusted by making provisions so that the position of the holding member of the ramp mechanism for holding the lift tab, relative to the fixing portion provided on the base, can be finely adjusted in corresponding relationship with the movement of the swing arm, i.e., the head actuator, that moves the head.

A storage device according to the present invention, which achieves the above object, is a storage device which, when in operation, reads and writes information on a storage medium by a head mounted at a tip of a swing arm and, when not in operation, retracts the head onto a ramp mechanism provided near an outer diameter of the storage medium, wherein the ramp mechanism comprises: a holding member having a ramp for holding a lift tab provided at a tip end of the swing arm; a mounting member provided on a base of the storage device and configured to mount the holding member thereon, the mounting member being provided with a guide that is used when moving the holding member in a direction conforming to a rotational path of the lift tab; and a fastening member for fastening the holding member to the mounting member.

A storage device housing according to the present invention, which achieves the above object, is a housing for encasing a storage device which, when in operation, reads and writes information on a storage medium by a head mounted at a tip of a swing arm and, when not in operation, retracts the head onto a ramp mechanism provided near an outer diameter of the storage medium, wherein when the ramp mechanism includes a holding member having a ramp for holding a lift tab provided at a tip end of the swing arm, a mounting member for mounting the holding member thereon is formed integrally with a base of the housing, and the mounting member is formed by including a guide that is used when moving the holding member in a direction conforming to a rotational path of the lift tab.

A storage device ramp mechanism according to the present invention, which achieves the above object, is a ramp mechanism for use in a storage device which, when in operation, reads and writes information on a storage medium by a head mounted at a tip of a swing arm and, when not in operation, retracts the head to a position near an outer diameter of the storage medium and holds the retracted head, wherein the ramp mechanism comprises: a holding member having a ramp for holding a lift tab provided at a tip end of the swing arm; a mounting member provided on a base of the storage device and configured to mount the holding member thereon, the mounting member being provided with a guide that is used when moving the holding member in a direction conforming to a rotational path of the lift tab; and a fastening member for fastening the holding member to the mounting member.

According to the present invention, the position of the ramp mechanism relative to the lift tab can be properly adjusted by finely adjusting the fixing portion of the ramp mechanism relative to the base in relation with the movement of the head actuator that moves the magnetic head.

### BRIEF DESCRIPTION OF THE DRAWINGS

FIG. 1 is a plan view depicting one example of a prior art load/unload type hard disk drive.

FIG. 2 is a perspective view depicting the configuration of a ramp mechanism in the load/unload type hard disk drive depicted in FIG. 1.

FIG. 3 is a diagram illustrating the problem associated with the prior art ramp mechanism depicted in FIG. 2.

FIG. 4 is an assembly diagram depicting the configuration of a ramp mechanism in a load/unload type hard disk drive according to a first embodiment of the present invention.

FIG. 5 is a plan view depicting, together with the tip of a head actuator, the ramp mechanism of the present invention of FIG. 4 in an assembled condition.

FIG. 6 is a diagram depicting the configuration of a modified example of the ramp mechanism according to the first embodiment of the present invention depicted in FIGS. 4 and 5.

FIG. 7 is an assembly diagram depicting the configuration of a ramp mechanism in a load/unload type hard disk drive according to a second embodiment of the present invention.

FIG. 8 is a perspective view depicting the configuration of a modified example of the ramp mechanism in the load/unload type hard disk drive according to the second embodiment of the present invention.

FIG. 9 is an assembly diagram depicting the configuration of a ramp mechanism in a load/unload type hard disk drive according to a third embodiment of the present invention.

FIG. 10 is an assembly diagram depicting the configuration of a ramp mechanism in a load/unload type hard disk drive according to a fourth embodiment of the present invention.

FIG. 11 is an assembly diagram depicting the configuration of a ramp mechanism in a load/unload type hard disk drive according to a fifth embodiment of the present invention.

### DESCRIPTION OF EMBODIMENTS

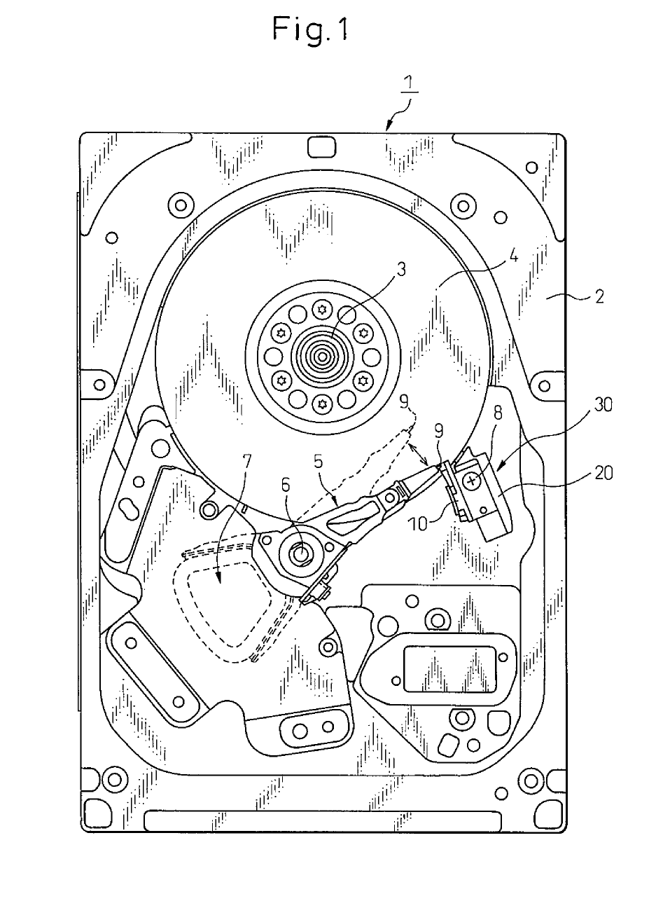

Before describing the preferred embodiments of the invention with reference to the accompanying drawings, the problem associated with the ramp mechanism employed in a typical prior art load/unload type hard disk drive will be described with reference to FIGS. 1 to 3.

FIG. 1 is a diagram depicting one example of the prior art load/unload type hard disk drive 1. At least one magnetic disk 4 as a storage medium is mounted at one side on a base 2 of the hard disk drive 11 and is rotated by a spindle motor; the magnetic disk 4 is composed of a large number of tracks for data recording.

At the other side on the base 2 of the hard disk drive 1, there is located a swing arm 5 that is equipped with a head (not depicted) for reading and writing data by accessing designated tracks on the magnetic disk 4. The head is attached at the tip of the swing arm 5. The swing arm 5 is rotatable about its axis of rotation 6, and a voice coil motor 7 for driving the swing arm 5 is located on the opposite side of the axis of rotation 6 from the swing arm 5.

In the load/unload type hard disk drive 1, the head is moved outside the magnetic disk 4 for unloading. For this purpose, in the load/unload type hard disk drive 1, a ramp mechanism 30 for holding the tip of the swing arm 5 is provided on the base 2 at a position near the outer diameter of the magnetic disk 4. The ramp mechanism 30 comprises a holding member 10 for holding the lift tab 9 provided at the tip of the swing arm 5 and a mounting member 20 for fixing the holding member 10 with respect to the base 2. The mounting member 20 is located outside the magnetic disk 4, while the holding member 10 is provided so as to partially overlap the magnetic disk 4.

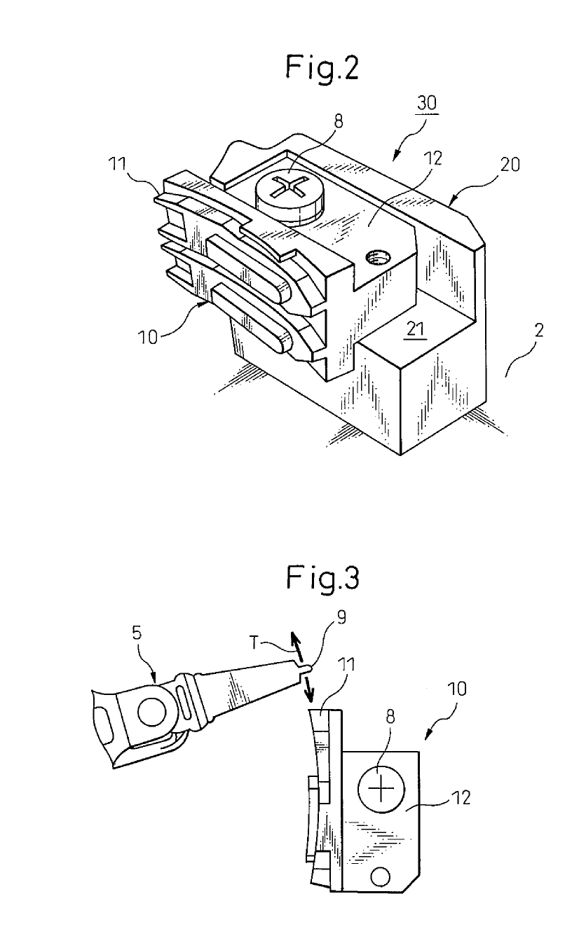

FIG. 2 is a diagram depicting the configuration of the ramp mechanism 30 in the load/unload type hard disk drive 1 depicted in FIG. 1. The ramp mechanism 30 comprises the holding member 10 made of plastic and the mounting member 20 formed integrally with the base 2. The mounting member 20 may be formed separately and rigidly fixed to the base 2. The holding member 10 includes a ramp 11 for holding the lift tab 1 depicted in FIG. 1 and a base portion 12 for mounting the holding member 10 to the mounting member 20. The base portion 12 is rigidly fixed with a screw 8 to a notch 21 formed in the mounting member 20.

FIG. 3 is a diagram illustrating how the lift tab 9 provided at the tip of the swing arm 5 is held on the ramp 11 of the holding member 10 depicted in FIG. 2. The swing arm side of the ramp 11 is formed to provide a circumferential face that conforms to the rotational path T of the swing arm 5. As a result, the lift tab 9 of the swing arm 5 rides over the ramp 11 as the swing arm 5 rotates, and thus the lift tab 9 is held in position outside the magnetic disk.

However, in the prior art hard disk drive 1, since the three axes x, y, and z of the holding member 10 are all fixed to the mounting member 20, it has not been possible to finely adjust the mounting position of the holding member 10 relative to the mounting member 20. The inability to finely adjust the mounting position of the holding member 10 has lead to the problem that when the position where the lift tab 9 contacts the ramp 11 in sliding fashion is displaced from the proper position depending on such factors as the mounting accuracy of the suspension attached at the tip of the swing arm 5, the position cannot be corrected to the proper position. As a result, the prior art has had the problem that if the positioning between the lift tab 9 and the ramp 11 is to be changed, equipment for assembling the ramp mechanism, etc. has to be changed accordingly, and the time and cost involved can be substantial.

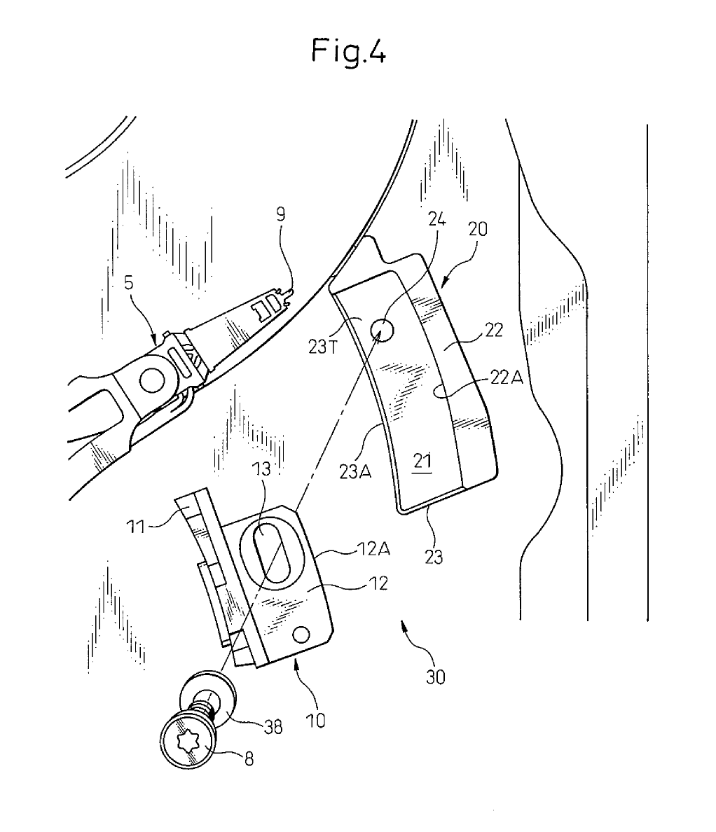

The present invention permits the position of the holding member 10 of the ramp mechanism 30 relative to the fixing portion 20 to be finely adjusted in corresponding relationship with the movement of the swing arm, and typical embodiments of the invention are illustrated in FIGS. 4 to 11. In the description of each embodiment of the invention, the same component members as those of the prior art ramp mechanism described with reference to FIGS. 1 to 3 are designated by the same reference numerals.

FIG. 4 is an assembly diagram depicting the configuration of a ramp mechanism 30 in a load/unload type hard disk drive according to a first embodiment of the present invention. In the first embodiment, the mounting hole opened through the base portion 12 of the holding member 10 is provided in the form of an elongated hole 13, and the elongated hole 13 is curved so as to lie on the circumference of a circle centered about the axis of rotation (not depicted) of the swing arm 5 when the holding member 10 is mounted on the mounting member 20. Further, a rear face 12A of the base portion 12 which is opposite from the ramp 11 is also formed to provide a circumferential face having the same curvature as the circle centered about the axis of rotation of the swing arm 5.

On the other hand, the mounting member 20 comprises a high wall portion 22 and a low wall portion 23, and is formed so that the base portion 12 of the holding member 10 is placed in the notch 21 bounded by a top face 23T of the low wall portion 23 and a sidewall of the high wall portion 22. Then, an inner circumferential face 22A of the high wall portion 22, which faces the rear face 12A of the base portion 12, is formed as a curved face having the same curvature as the rear face 12A of the base portion 12. The top face 23T of the low wall portion 23 is provided with a screw hole 24 in a position over which the base portion 12 of the holding member 10 is placed. In this embodiment, an inner circumferential face 23A of the low wall portion 23 is also formed as a curved face having the same curvature as the circle centered about the axis of rotation of the swing arm 5; in this case, the rear face side of the ramp 11 should also be formed as a curved face having the same curvature. If the rear face side of the ramp 11 is not a curved face, then the inner circumferential face 23A need not be limited to any specific shape as long as it does not interfere with the movement of the ramp 11.

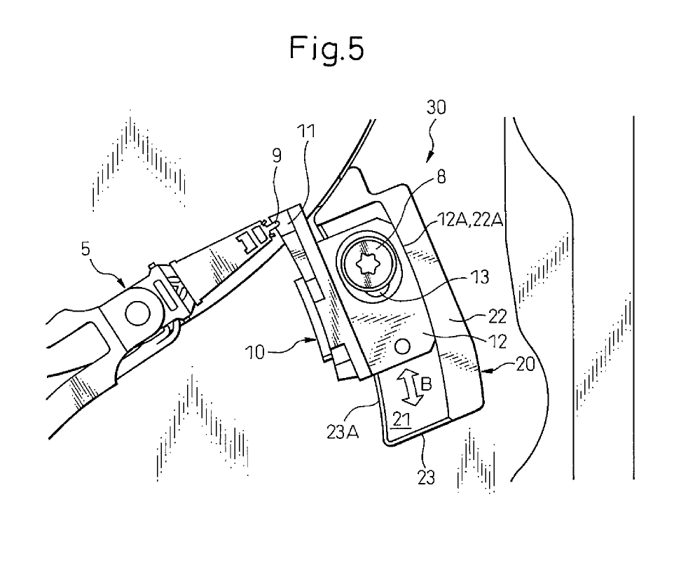

The thus constructed holding member 10 is placed in the notch 21 of the mounting member 20 by holding the rear face 12A of the base portion 12 against the inner circumferential face 22A of the high wall portion 22. Then, the screw 8 is inserted through a washer 38 into the elongated hole 13, and threaded into the screw hole 24 formed in the top face 23T of the low wall portion 23; the screw 8 is then gently tightened to tentatively fasten the holding member 10 to the mounting member 20. This condition is illustrated in FIG. 5.

After that, the holding member 10 is moved for fine adjustment in the direction of arrow B within the notch 21 so that the lift tab 9 will be properly held on the ramp 11 when the swing arm 5 comes to the unload position; then, the screw 8 is securely tightened in the proper position to fix the holding member 10 onto the mounting member 20. Since the screw hole 13 and the rear face 12A of the base portion 12, and thus the inner circumferential face 22A of the high wall portion 22, lie on concentric circles centered about the axis of rotation of the swing arm 5, the movement of the holding member 10 in the direction of arrow B matches the direction of movement of the lift tab 9. Accordingly, after temporarily fastening the holding member 10 to the mounting member 20, the position of the ramp 11 can be adjusted to the optimum position along the direction of movement of the lift tab 9. Generally, the distance over which the ramp 11 is moved for fine adjustment is about 1 to 2 mm.

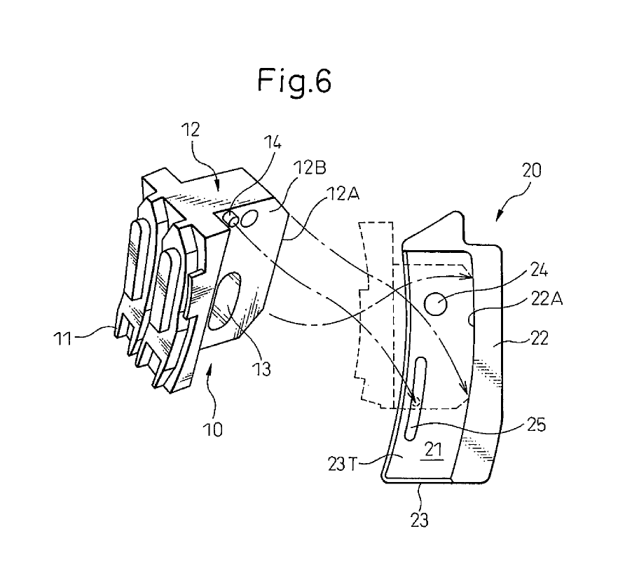

FIG. 6 is a diagram depicting the configuration of a modified example of the ramp mechanism 30 according to the first embodiment of the present invention depicted in FIGS. 4 and 5. In the ramp mechanism 30 according to the first embodiment of the invention depicted in FIGS. 4 and 5, since there is a suitable gap between the screw hole 13 and the shaft of the screw 8, only the inner circumferential face 22A of the high wall portion 22 can, in effect, serve as a guide when moving the holding member 10 in the direction of arrow B within the notch 21, so that the holding member 10 is moved by allowing the rear face 12A of the base portion 12 to slide along the inner circumferential face 22A of the high wall portion 22.

The modified example depicted in FIG. 6 provides an additional member that serves as a guide when moving the holding member 10 in the direction of arrow B within the notch 21. That is, in this modified example, a guide protrusion 14 is provided in protruding fashion on a bottom face 12B of the base portion 12 of the holding member 10 at a position spaced away from the rear face 12A, and a guide groove 25 with the same curvature as the circle centered about the axis of rotation of the swing arm 5, and with the groove width equal to the diameter of the guide protrusion 14, is formed in the top face 23T of the low wall portion 23 at a position corresponding to the guide protrusion 14.

According to this configuration, since two members, the guide groove 25 and the inner circumferential face 22A of the high wall portion 22, serve as the guides when moving the holding member 10 in the direction of arrow B within the notch 21, the holding member 10 can be moved within the notch 21 in a stable manner.

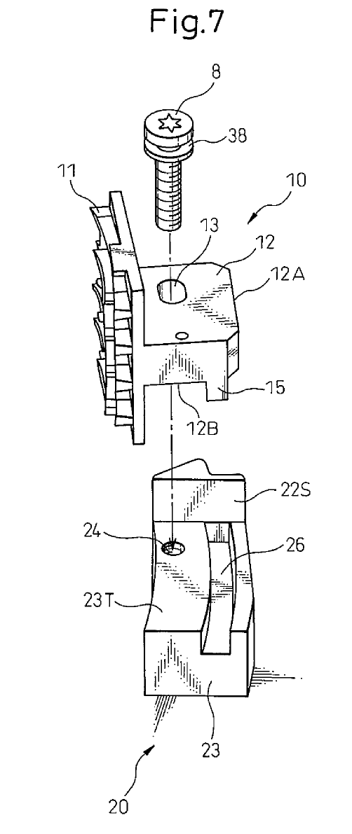

FIG. 7 is an assembly diagram depicting the configuration of a ramp mechanism 30 in a load/unload type hard disk drive 1 according to a second embodiment of the present invention. In the second embodiment, as in the first embodiment, the mounting hole opened through the base portion 12 of the holding member 10 is provided in the form of an elongated hole 13 which is curved so as to lie on the circumference of a circle centered about the axis of rotation of the swing arm 5. In the second embodiment, the rear face 12A of the base portion 12 which is opposite from the ramp 11 need not be formed as a curved face but may be formed as a planar face.

On the other hand, in the second embodiment, the bottom face 12B of the base portion 12 of the holding member 10 is provided with a guide protrusion (rail) 15 that is curved like an arc so that its inner and outer circumferential faces lie on concentric circles centered about the axis of rotation of the swing arm 5. The mounting member 20 which receives the holding member 10 is constructed from a low wall portion 23, except for an end portion formed as a stopper wall 22S that limits the movement of the holding member 10. The top face 23T of the low wall portion 23 is provided with a screw hole 24 in a position aligned with the elongated hole 13 of the holding member 10, and a guide groove 26 as a curved groove whose inner and outer circumferential faces lie on concentric circles centered about the axis of rotation of the swing arm 5, and along which the guide rail 15 can be moved in sliding fashion, is formed in a portion that faces the guide rail 15.

The ramp mechanism 30 of the second embodiment is assembled by inserting the guide rail 15, provided in protruding fashion on the bottom face 12B of the base portion 12 of the holding member, into the guide groove 26 formed in the mounting member 20. Then, the screw 8 is inserted through the washer 38 into the elongated hole 13, and threaded into the screw hole 24 formed in the top face 23T of the low wall portion 23; the screw 8 is then gently tightened to tentatively fasten the holding member 10 to the mounting member 20. After that, the holding member 10 can be securely fixed to the mounting member 20 in the same manner as in the first embodiment.

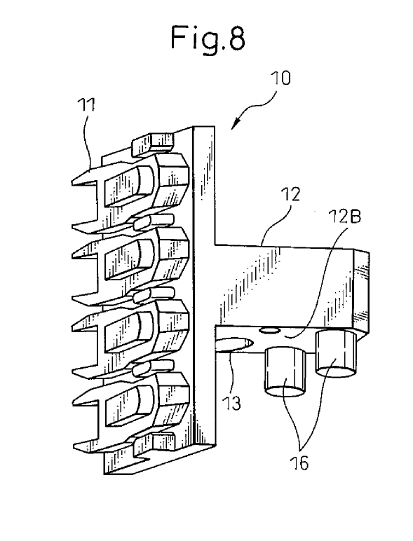

FIG. 8 is a perspective view depicting the configuration of a modified example of the ramp mechanism 30 in the load/unload type hard disk drive 1 according to the second embodiment of the present invention. The only difference between the modified example depicted in FIG. 8 and the second embodiment depicted in FIG. 7 is the shape of the holding member 10. More specifically, in the holding member 10 of the second embodiment, the arc-shaped guide rail 15 is provided on the bottom face 12B of the base portion 12, but in the modified example of the second embodiment, instead of the guide rail 15, two guide protrusions 16 are provided in protruding fashion on the bottom face 12B of the base portion 12. Needless to say, the diameter of each of the two guide protrusions 16 is equal to the groove width of the guide groove 26 formed in the mounting member 20, and their positions lie on the circumference of the same circle centered about the axis of rotation of the swing arm.

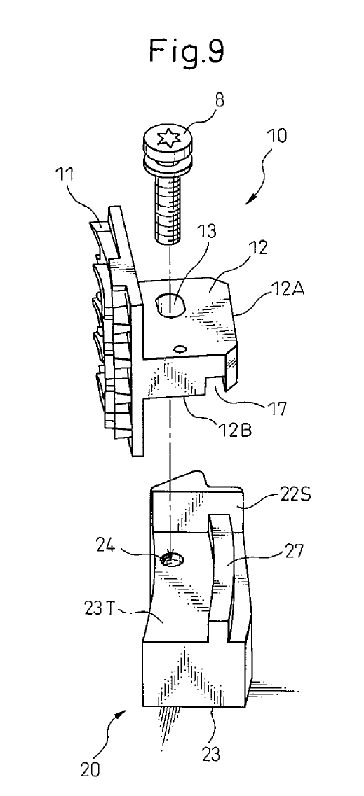

FIG. 9 is an assembly diagram depicting the configuration of a ramp mechanism 30 in a load/unload type hard disk drive 1 according to a third embodiment of the present invention. In the third embodiment, as in the first embodiment, the mounting hole opened through the base portion 12 of the holding member 10 is provided in the form of an elongated hole 13 which is curved so as to lie on the circumference of a circle centered about the axis of rotation of the swing arm 5. In the third embodiment, the rear face 12A of the base portion 12 which is opposite from the ramp 11 need not be formed as a curved face but may be formed as a planar face.

On the other hand, in the third embodiment, the bottom face 12B of the base portion 12 of the holding member 10 is provided with a guide groove 17 that is curved like an arc so that its inner and outer circumferential faces lie on concentric circles centered about the axis of rotation of the swing arm 5. The mounting member 20 which receives the holding member 10 is constructed from a low wall portion 23 except an end portion formed as a stopper wall 22S that limits the movement of the holding member 10. The top face 23T of the low wall portion 23 is provided with a screw hole 24 in a position aligned with the elongated hole 13 of the holding member 10, and an arc-shaped guide protrusion (rail) 27 whose inner and outer circumferential faces lie on concentric circles centered about the axis of rotation of the swing arm 5, and which can be inserted in the guide groove 17 and moved along it in sliding fashion, is formed in a portion that faces the guide groove 17.

To assemble the ramp mechanism 30 of the third embodiment, the guide rail 27 provided on the mounting member 20 is inserted into the guide groove 17 formed in the bottom face 12B of the base portion 12 of the holding member. Then, the screw 8 is inserted through the washer 38 into the elongated hole 13, and threaded into the screw hole 24 formed in the top face 23T of the low wall portion 23; the screw 8 is then gently tightened to tentatively fasten the holding member 10 to the mounting member 20. After that, the holding member 10 can be securely fixed to the mounting member 20 in the same manner as in the first embodiment.

Though not depicted or described in detail herein, in a modified example of the configuration of the third embodiment of the present invention, a plurality of guide protrusions may be formed on the top face 23T of the low wall portion 23 instead of the guide rail 27 provided on the mounting member 20, just like the guide protrusions 16 depicted in FIG. 8 are provided instead of the guide rail 15 depicted in FIG. 7.

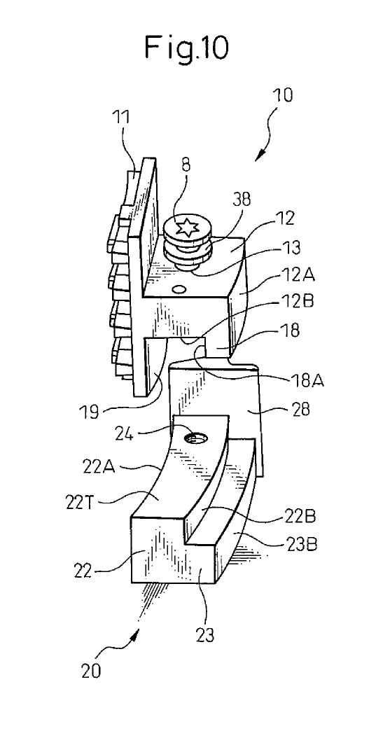

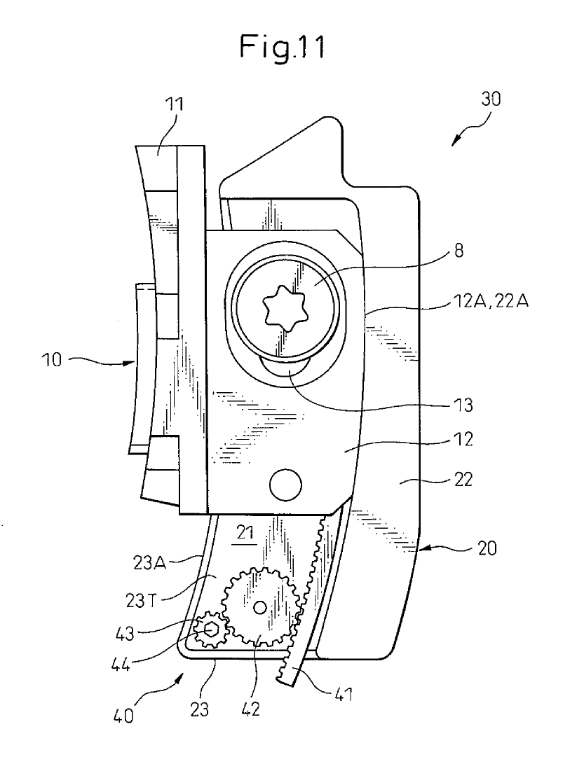

FIG. 10 is an assembly diagram depicting the configuration of a ramp mechanism in a load/unload type hard disk drive 1 according to a fourth embodiment of the present invention. In the fourth embodiment, the mounting member 20 comprises a low wall portion 23 and a high wall portion 22 higher than the low wall portion 23, the high wall portion 22 being formed on the inner side of the low wall portion 23 (that is, on the side nearer to the lift tab). The outer circumferential face of the high wall portion 22 is formed as a circumferential face whose center of curvature is at the axis of rotation of the swing arm, the circumferential face thus providing a guide face 22B. Likewise, the inner circumferential face 22A of the high wall portion 22 is also formed as a circumferential face whose center of curvature is at the axis of rotation of the swing arm, the circumferential face thus providing a guide face; to match the thus formed face, a rear face 19 of a portion forming the ramp 11 on the holding member 10, the rear face 19 being a part to be placed against the inner circumferential face (guide face) 22A of the high wall portion 22, is formed as a curved face having the same curvature as the inner circumferential face 22A of the high wall portion 22. The outer circumferential face 23B of the low wall portion 23 may also be formed as a circumferential face whose center of curvature is at the axis of rotation of the swing arm, or may be formed as some other curved face or as a planar face.

On the other hand, an elongated hole 13, similar to the one formed in the first to third embodiments, is formed through the holding member 10, and a protruding rail 18 protruding toward the low wall portion 23 is formed along the outer circumferential edge of the bottom face 12B of the base portion 12. The inner circumferential face 18A of the protruding rail 18 is formed so as to match the shape of the outer circumferential face (guide face) 22B of the high wall portion 22. A screw hole 24 is formed in the top face 22T of the high wall portion 22, and a stopper wall 28 higher than the high wall portion 22 is formed at an end of the high wall portion that is nearer to the disk.

To assemble the ramp mechanism 30 of the fourth embodiment, the rear face 19 of the portion forming the ramp 11 on the holding member 10 is brought close to the mounting member 20 in such a manner as to slide along the inner circumferential face 22A of the high wall portion 22, and the inner circumferential face 18A of the protruding rail 18 provided on the bottom face 12B of the base portion 12 of the holding member is made to fit against the outer circumferential face 22B of the high wall portion 22 of the mounting member 20.

As a result, with the inner circumferential face 22A and outer circumferential face 22B of the high wall portion 22 serving as guides, the holding member 10 can be fitted onto the mounting member 20 and moved along the circumferential direction of a circle centered about the axis of rotation of the swing arm. Then, the screw 8 is inserted through the washer 38 into the elongated hole 13, and threaded into the screw hole 24 formed in the top face 23T of the low wall portion 23; the screw 8 is then gently tightened to tentatively fasten the holding member 10 to the mounting member 20. After that, the holding member 10 can be securely fixed to the mounting member 20 in the same manner as in the first embodiment.

FIG. 11 is a plan view depicting the configuration of a ramp mechanism in a load/unload type hard disk drive 1 according to a fifth embodiment of the present invention. The fifth embodiment is identical to the first embodiment depicted in FIG. 5, except that a moving mechanism 40 for moving the holding member 10 is added at one end of the base portion 12 of the holding member 10 in the ramp mechanism 30 of the first embodiment. Since the configuration of the ramp mechanism 30 of the first embodiment has already been described, the description will not be repeated.

The moving mechanism 40 for the holding member 10 comprises a rack 41 formed in protruding fashion on the base portion 12 of the holding member 10, a pinion 42 that has its axis of rotation on the top face 23T of the low wall portion 23 of the mounting member 20 and engages with the rack 41, and a driving gear 43 that has its axis of rotation on the top face 23T of the low wall portion 23 of the mounting member 20 and engages with the pinion 42 for rotation. The rack 41 is curved to conform to the circumference of a circle centered about the axis of rotation of the swing arm.

In this embodiment, the diameter of the pinion 42 is increased to increase the number of its teeth and the diameter of the driving gear 43 is reduced to reduce the number of its teeth, thereby reducing the number of revolutions of the pinion 42 relative to the number of revolutions of the driving gear 43 so that the movement of the rack 41 can be finely adjusted. Further, the driving gear 43 has a hexagonal slot 44 so that it can be easily rotated from outside by using a tool such as a hexagonal wrench. The larger the ratio of the number of teeth on the pinion 42 to the number of teeth on the driving gear 43, the easier the fine adjustment.

The moving mechanism 40 for the holding member 10 can not only be added to the first embodiment, but also be added to the ramp mechanism 30 of any of the second to fourth embodiments. In each of the above embodiments, a screw has been used to fasten the holding member to the mounting member, but the fastener used to fasten the holding member to the mounting member is not limited to a screw, but an adhesive may be used to bond them together if no further adjustment is needed once the position of the holding member relative to the mounting member has been adjusted.

What is claimed is:

1. A storage device which, when in operation, reads and writes information on a storage medium by a head mounted at a tip of a swing arm and, when not in operation, retracts said head onto a ramp mechanism provided near an outer diameter of said storage medium, wherein said ramp mechanism comprises:
a holding member having a ramp for holding a lift tab provided at a tip end of said swing arm;
a mounting member provided on a base of said storage device and configured to mount said holding member thereon, said mounting member being provided with a guide that is used when moving said holding member in a direction conforming to a rotational path of said lift tab; and
a fastening member for fastening said holding member to said mounting member.

2. A storage device as claimed in claim 1, wherein
an elongated hole extending along a direction of movement of said holding member is formed passing through said holding member from top to bottom thereof,
a screw hole that aligns with said elongated hole when said holding member is mounted is formed in said mounting member, and
said fastening member is a screw which is threaded into said screw hole by passing through said elongated hole.

3. A storage device as claimed in claim 2, wherein
a face of said mounting member that is to contact a rear face of said holding member is formed as a circumferential face whose center of curvature is at an axis of rotation of said swing arm, said face thus being configured as said guide, and
said rear face of said holding member is formed as a circumferential face with the same curvature as said guide.

4. A storage device as claimed in claim 3, wherein
said mounting member is constructed from a low wall portion and a high wall portion higher than said low wall portion,
said high wall portion is formed on an outside side of said low wall portion to form said guide, and
said screw hole is formed in a top face of said low wall portion.

5. A storage device as claimed in claim 4, wherein
a guide groove extending along the direction of movement of said holding member is formed in the top face of said low wall portion in an area thereof spaced away from said high wall portion, and
at least one guide pin capable of moving in said guide groove in sliding fashion is provided on a bottom face of said mounting member.

6. A storage device as claimed in claim 2, wherein
said guide is formed as a curved groove in a top face of said mounting member so as to conform to a circumference of a circle centered about an axis of rotation of said swing arm, and
an arc-shaped protruding rail that moves in said circumferential groove in sliding fashion is provided on a bottom face of said holding member.

7. A storage device as claimed in claim 2, wherein
said guide is formed as a curved groove in a top face of said mounting member so as to conform to a circumference of a circle centered about an axis of rotation of said swing arm, and
at least two cylindrically shaped protrusions capable of moving in said circumferential groove in sliding fashion are provided on a bottom face of said holding member in such a manner as to be disposed on the circumference of the circle centered about the axis of rotation of said swing arm.

8. A storage device as claimed in claim 2, wherein
said guide is formed as an arc-shaped rail on a top face of said mounting member so as to conform to a circumference of a circle centered about an axis of rotation of said swing arm, and
a circumferential groove that receives said rail and that allows said rail to move therein in sliding fashion is formed in a bottom face of said holding member.

9. A storage device as claimed in claim 3, wherein
said mounting member is constructed from a low wall portion and a high wall portion higher than said low wall portion,
said high wall portion is formed on an inner side of said low wall portion, said guide being formed by forming an outer circumferential face of said high wall portion as a circumferential face whose center of curvature is at the axis of rotation of said swing arm,
a protruding rail protruding toward said low wall portion is formed on a bottom face of said holding member, an inner circumferential face of said protruding rail being formed to conform to the shape of the outer circumferential face of said high wall portion, and
said screw hole is formed in a top face of said high wall portion.

10. A storage device as claimed in claim 1, further comprising:
a driving mechanism which includes, at least, a rack mounted on said holding member in a direction extending along said guide, and a pinion rotatably supported on said mounting member for engaging said rack, wherein
provisions are made to be able to move said holding member by rotating said pinion from outside.

11. A housing for encasing a storage device which, when in operation, reads and writes information on a storage medium by a head mounted at a tip of a swing arm and, when not in operation, retracts said head onto a ramp mechanism provided near an outer diameter of said storage medium, wherein
when said ramp mechanism includes a holding member having a ramp for holding a lift tab provided at a tip end of said swing arm,
a mounting member for mounting said holding member thereon is formed integrally with a base of said housing, and
said mounting member is formed by including a guide that is used when moving said holding member in a direction conforming to a rotational path of said lift tab.

12. A housing for encasing a storage device as claimed in claim 11, wherein
when said holding member is provided with an elongated hole that is formed extending along a direction of movement of said holding member and passing through said holding member from top to bottom thereof,
a screw hole that aligns with said elongated hole when said holding member is mounted is formed in said mounting member.

13. A housing for encasing a storage device as claimed in claim 12, wherein
when a rear face of said holding member is formed as a circumferential face whose center of curvature is at an axis of rotation of said swing arm,
said mounting member is constructed from a low wall portion and a high wall portion higher than said low wall portion, and
a face of said high wall portion that is to contact the rear face of said holding member is formed as a circumferential face having the same curvature as the circumferential face of said holding member and thus providing said guide.

14. A housing for encasing a storage device as claimed in claim 12, wherein
when a bottom face of said holding member is provided with an arc-shaped protruding rail formed so as to conform to a circumference of a circle centered about an axis of rotation of said swing arm or with at least two cylindrically shaped protrusions disposed on the circumference of the circle centered about the axis of rotation of said swing arm,
a circumferential groove for receiving said arc-shaped protruding rail or said at least two cylindrically shaped protrusions in slidable fashion is formed as said guide in said mounting member.

15. A housing for encasing a storage device as claimed in claim 12, wherein
when a bottom face of said holding member is provided with a curved groove formed so as to conform to a circumference of a circle centered about an axis of rotation of said swing arm,
an arc-shaped rail capable of moving in said circumferential groove in sliding fashion is formed as said guide on said mounting member.

16. For use in a storage device which, when in operation, reads and writes information on a storage medium by a head mounted at a tip of a swing arm and, when not in operation, retracts said head to a position near an outer diameter of said storage medium, a ramp mechanism for holding said retracted head, comprising:
a holding member having a ramp for holding a lift tab provided at a tip end of said swing arm;
a mounting member provided on a base of said storage device and configured to mount said holding member thereon, said mounting member being provided with a guide that is used when moving said holding member in a direction conforming to a rotational path of said lift tab; and
a fastening member for fastening said holding member to said mounting member.

17. A ramp mechanism for use in a storage device as claimed in claim 16, wherein
an elongated hole extending along a direction of movement of said holding member is formed passing through said holding member from top to bottom thereof, and
a screw hole that aligns with said elongated hole when said holding member is mounted is formed in said mounting member.

18. A ramp mechanism for use in a storage device as claimed in claim 16, wherein
a side face of said holding member which is opposite from said ramp is formed to provide a circumferential face whose center of curvature is at an axis of rotation of said swing arm, and
said mounting member is constructed from a low wall portion and a high wall portion higher than said low wall portion, wherein a circumferential face having the same curvature as the circumferential face of said holding member is formed as said guide on said high wall portion.

19. A ramp mechanism for use in a storage device as claimed in claim 16, wherein
a bottom face of said holding member is provided with an arc-shaped protruding rail formed so as to conform to a circumference of a circle centered about an axis of rotation of said swing arm or with at least two cylindrically shaped protrusions disposed on the circumference of the circle centered about the axis of rotation of said swing arm, and
a circumferential groove for receiving said arc-shaped protruding rail or said at least two cylindrically shaped protrusions in slidable fashion is formed as said guide in said mounting member.

20. A ramp mechanism for use in a storage device as claimed in claim 16, wherein
a bottom face of said holding member is provided with a curved groove formed so as to conform to a circumference of a circle centered about an axis of rotation of said swing arm, and
an arc-shaped rail capable of moving in said circumferential groove in sliding fashion is formed as said guide on said mounting member.
